(19) United States
(12) Patent Application Publication
(10) Pub. No.: US 2017/0061745 A1
(43) Pub. Date: Mar. 2, 2017

(54) AUTOMATIC TELLER MACHINE AND MEDIUM PROCESSING DEVICE

(71) Applicant: Oki Electric Industry Co., Ltd., Tokyo (JP)

(72) Inventor: Hiroyuki KOBAYASHI, Tokyo (JP)

(73) Assignee: OKI ELECTRIC INDUSTRY CO., LTD., Tokyo (JP)

(21) Appl. No.: 15/308,344

(22) PCT Filed: Apr. 23, 2015
(86) PCT No.: PCT/JP2015/062401

§ 371 Date: Nov. 1, 2016

(30) Foreign Application Priority Data
May 9, 2014 (JP) 2014-097379

(51) Int. Cl. G07F 19/00

(52) U.S. Cl. CPC G07F 19/2055; G07F 19/203; G07F 19/202

(57) ABSTRACT

An automatic teller machine of the present invention performs specific transaction processing using a medium to which a magnetic data storage section is affixed, and the automatic teller machine includes one or plural illicit device detectors that generate a magnetic field toward a vicinity of an input/output port for a medium and capture changes in a magnetic field caused by metal, one or plural magnetic data obstruction sections that generate a magnetic field and obstruct reading of magnetic data stored on a magnetic data storage section affixed to an inserted medium or a dispensed medium, and a controller that controls the plural magnetic data obstruction section and the illicit device detector operation.

### TECHNICAL FIELD

The present invention relates to an automatic teller machine and a medium processing device, and is applicable to automatic teller machines and medium processing devices that prevent and detect illicit acquisition of card information from an automatic teller machine such as an automatic teller machine (ATM) installed in a financial institution, a convenience store, a train station, or an airport.

### BACKGROUND ART

For example, there is rising illicit acquisition activity in which a magnetic data reader (known as a skimming device) is illicitly attached to a card insertion/dispensing port of an automatic teller machine and card information recorded on a magnetic card, such as a cash card or a credit card, is illicitly acquired. Illicitly acquired card information is recorded onto fake cards to make illicit transactions.

Hitherto, technology is known that prevents illicit card information acquisition activity by generating a magnetic field to obstruct reading of card information (magnetic data) by magnetic data readers when the card is inserted into an automatic teller machine (see Japanese Patent Application Laid-Open (JP-A) No. 2007-164533).

### SUMMARY OF INVENTION

### Technical Problem

However, when only the conventional technology described above is employed, illicit attachment of a magnetic data reader is not detected. Moreover, with each passing day, perpetrators of illicit activity conceive of new skimming technologies and continue to perform illicit activity by cunning modus operandi. Thus, when reading of card information is not reliably obstructed, there is a potential for further harm in the time it takes to realize the fact that a magnetic data reader has been illicitly attached.

There is therefore a strong desire for an automatic teller machine and a medium processing device that can detect attachment of illicit devices, and can effectively obstruct illicit reading of magnetic data.

### Solution to Problem

To solve this problem, a first aspect of the present invention is an automatic teller machine that performs specific transaction processing using a medium to which a magnetic data storage section is affixed, and the automatic teller machine includes (1) one or plural illicit device detector means that generate a magnetic field toward a vicinity of an input/output port for a medium and capture changes in a magnetic field caused by metal, (2) one or plural magnetic data obstruction means that generate a magnetic field and obstruct reading of magnetic data stored on a magnetic data storage section affixed to an inserted medium or a medium being dispensed, and (3) a control means that controls the magnetic data obstruction means and the illicit device detector means operation.

A second aspect of the present invention is a medium processing device including (1) one or plural illicit device detectors that generate a magnetic field toward a vicinity of an input/output port for a medium and capture changes in a magnetic field caused by metal, (2) one or plural magnetic data obstruction sections that generate a magnetic field and obstruct reading of magnetic data stored on a magnetic data storage section affixed to an inserted medium or a dispensed medium, (3) and a controller that controls the magnetic data obstruction section and the illicit device detector operation.

### Advantageous Effects of Invention

According to the present invention, illicit attachment of a magnetic data reader can be detected, and illicit reading of magnetic data can be effectively obstructed.

### BRIEF DESCRIPTION OF DRAWINGS

FIG. 1 is an overall configuration diagram illustrating an overall configuration of a monitoring system according to a first exemplary embodiment.

FIG. 2 is a block diagram illustrating primary configuration of an ATM according to the first exemplary embodiment.

FIG. 3 is an internal configuration diagram illustrating an internal configuration of a medium processing device according to the first exemplary embodiment.

FIG. 4 is an explanatory diagram for explaining processing operations of a medium processing device in cases of pay-in processing in an ATM according to the first exemplary embodiment.

FIG. 5 is an explanatory diagram for explaining a detection mode of a medium processing device according to the first exemplary embodiment.

FIG. 6 is an explanatory diagram for explaining a processing operation when a magnetic data reader has been detected according to the first exemplary embodiment.

FIG. 7 is an explanatory diagram for explaining an obstruction mode of a medium processing device according to the first exemplary embodiment.

FIG. 8A is an explanatory diagram for explaining regeneration of magnetic data by a magnetic data reader under obstruction mode of a medium processing device according to the first exemplary embodiment.

FIG. 8B is an explanatory diagram for explaining regeneration of magnetic data by a magnetic data reader under an obstruction mode of a medium processing device according to the first exemplary embodiment.

FIG. 8C is an explanatory diagram for explaining regeneration of magnetic data by a magnetic data reader under an obstruction mode of a medium processing device according to the first exemplary embodiment.

FIG. 8D is an explanatory diagram for explaining regeneration of magnetic data by a magnetic data reader under an obstruction mode of a medium processing device according to the first exemplary embodiment.

FIG. 8E is an explanatory diagram for explaining regeneration of magnetic data by a magnetic data reader under an obstruction mode of a medium processing device according to the first exemplary embodiment.

FIG. 9 is an explanatory diagram for explaining a detection mode when a card has been inserted into a medium processing device according to the first exemplary embodiment.

FIG. 10 is a diagram illustrating an example of a screen when halting dealings with an ATM after a magnetic data reader under detection mode of a medium processing device according to the first exemplary embodiment.

FIG. 11 is a block diagram illustrating primary configuration of an ATM according to a second exemplary embodiment.

FIG. 12 is an explanatory diagram for explaining a processing operation when a magnetic data reader has been detected according to the second exemplary embodiment.

### DESCRIPTION OF EMBODIMENTS

(A) First Exemplary Embodiment

Detailed explanation follows regarding a first exemplary embodiment of an automatic teller machine and a medium processing device according to the present invention, with reference to the drawings.

In the first exemplary embodiment, an example is given of a case in which the present invention is applied to an ATM and a monitoring system installed in a financial institution, a convenience store, a train station, an airport, or the like.

(A-1) Configuration of First Exemplary Embodiment

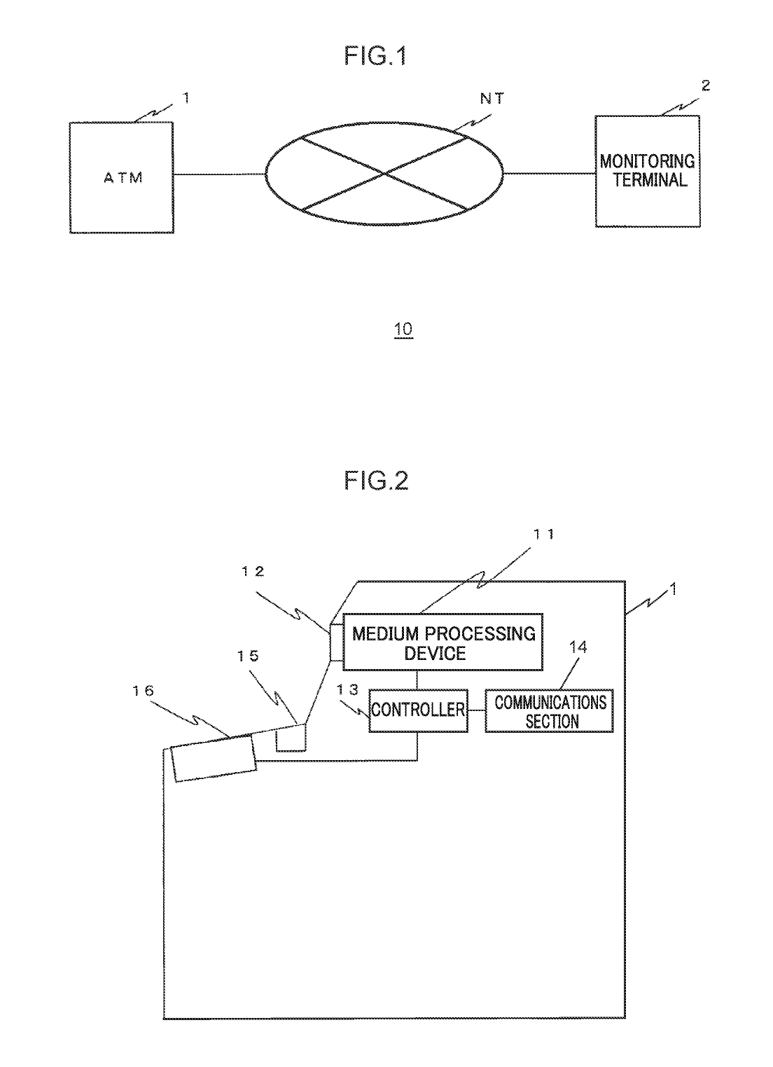

FIG. 1 is an overall configuration diagram illustrating an overall configuration of a monitoring system according to the first exemplary embodiment. In FIG. 1, a monitoring system 10 according to the first exemplary embodiment includes an ATM 1 and a monitoring terminal 2, which are capable of connecting to a network NT.

The monitoring system of the first exemplary embodiment 10 illustrated in FIG. 1 may be installed in, for example, a store, or may, for example, be employed as a remote system capable of exchanging information with a store and a management center.

Although FIG. 1 gives an example of a case in which there is just one ATM 1, plural ATMs 1 may be connected to the network NT, and the monitoring terminal 2 may monitor the state of the plural ATMs 1.

The network NT is a communications network that exchanges information between the ATM 1 and the monitoring terminal 2. As long the protocol of the network NT ensures network security, the protocol is not particularly limited, and, for example, a protocol unique to the financial institution, or TCP/IP (an internet protocol) may be employed.

The ATM 1 is a device that performs transactions, and is installed in, for example, a financial institution, an airport, a train station, or a convenience store. The ATM 1, for example, displays menu screens for selecting transaction types, displays reception and confirmation screens for inputting information needed for transactions, and takes in and dispenses cash (banknotes and coins) related to transactions. For a transaction type selected by a customer operation, the ATM 1 transmits transaction information including information needed for the transaction and transaction content information to a financial institution host server, or receives transaction execution information to be executed by the financial institution host server, and completes the transaction.

Examples of transaction types that can be dealt with by the ATM 1 include pay-in transactions and pay-out transactions. Pay-in transactions are transactions in which cash received from a customer is paid in, and examples thereof include deposit transactions in which cash is deposited into an ordinary bank account, fixed deposit pay-in transactions in which cash is deposited into a fixed deposit bank account, and transfer transactions in which cash is transferred to a specific bank account. Pay-out transactions are transactions in which cash is paid to the customer, and examples thereof include withdrawal transactions in which cash is withdrawn from a bank account.

The monitoring terminal 2 is a device that remotely monitors the ATM 1 by acquiring information, through the network NT, indicating the state of the ATM 1 from a device installed to the ATM 1 (such as a monitoring camera or a medium processing device, described later) or from surrounding equipment (such as a monitoring camera) provided in the surroundings of the ATM 1. When the monitoring terminal 2 has received a notification from the ATM 1 stating that illicit attachment of a magnetic data reader has been detected, the monitoring terminal 2 outputs a specific alarm (by, for example, outputting an alarm display, an alarm sound, an alarm voice, or the like). This enables monitoring staff to instruct specific security (such as assigning security to the place where the ATM 1 is installed).

FIG. 2 is a block diagram illustrating the main configuration if the ATM 1 according to the first exemplary embodiment. In FIG. 2, the ATM 1 according to the first exemplary embodiment includes a medium processing device 11, a card input/output port 12, a controller 13, a communications section 14, a pay-in/pay-out section 15, an operation panel section 16, and the like.

The card input/output port 12 is a section that accepts insertion of, or dispenses, media such as cash cards, credit cards, and the like.

The medium processing device 11 controls opening and closing of a shutter of the card input/output port 12, performs insertion/dispensing control on cards inserted into the card input/output port 12, and reads data, or writes data, stored on a magnetic strip (also referred to as a magnetic data storage section) affixed to an inserted card. The medium processing device 11 provides read data to the controller 13, or writes data from the controller 13 to the magnetic strip.

The medium processing device 11 also includes functionality for detecting magnetic data readers illicitly attached to the card input/output port 12, and obstructs processing that uses the magnetic data reader to read data from the magnetic strip of the card. Namely, the medium processing device 11 has both functionality for detecting magnetic card readers, and functionality for obstructing illicit data reading. This enables the size of the medium processing device 11 to be made more compact, and not only enables obstruction of data reading, but also enables magnetic data readers to be detected.

When the medium processing device 11 has detected that a magnetic data reader has been illicitly attached, the medium processing device 11 notifies the controller 13 of the detection data, and reports to the monitoring terminal 2 through the communications section 14. This enables illicit attachment of magnetic data readers to be reported, and maintenance staff can then be made aware that a magnetic data reader has been illicitly attached.

The controller 13 controls transaction processing in the ATM 1, controls various functions of the ATM 1, and controls display of screens related to transactions on the operation panel section 16 of the ATM 1. The controller 13 includes, for example, a CPU, ROM, RAM, EEPROM, and an input/output interface section. The CPU can implement various functions of the ATM 1 by executing a processing program stored in the ROM. The controller 13 includes a transaction processing section for each transaction type for performing the transaction processing of each type of transaction.

When the medium processing device 11 has detected that a magnetic data reader has been illicitly attached, the controller 13 notifies the monitoring terminal 2 of this via the communications section 14, and halts dealings with the ATM 1, in order to avoid further harm.

The communications section 14 exchanges information with the financial institution host server or with a monitoring terminal 2 of a monitoring center, through a communication line. The communications section 14 controls the controller 13 such that, when the medium processing device 11 has detected that a magnetic data reader has been illicitly attached, the monitoring terminal 2 is notified of this.

Here, in order for the communications section 14 to notify the monitoring terminal 2 of illicit attachment of the magnetic data reader, the monitoring terminal 2 may be notified of information including information identifying the place where the ATM 1 is installed (for example, information including a financial institution name, a financial institution code, a branch name, a branch code, or the like), detection time information, or and the like. The information notified to the monitoring terminal 2 is not limited to the information given as an example above.

The pay-in/pay-out section 15 is a section that takes in and dispenses banknotes or coins according to the transaction. The pay-in/pay-out section 15 includes a banknote pay-in/pay-out section that takes in and dispenses banknotes, and a coin pay-in/pay-out section that takes in and dispenses coins.

The operation panel section 16 accepts control from the controller 13, inputs transaction types selected by the customer and information related to transactions, and displays information related to transactions. The operation panel section 16 may, for example, employ an operation display section that employs a touch panel system physically integrating the input section and the display section together, or the input section and the display section may be physically different sections.

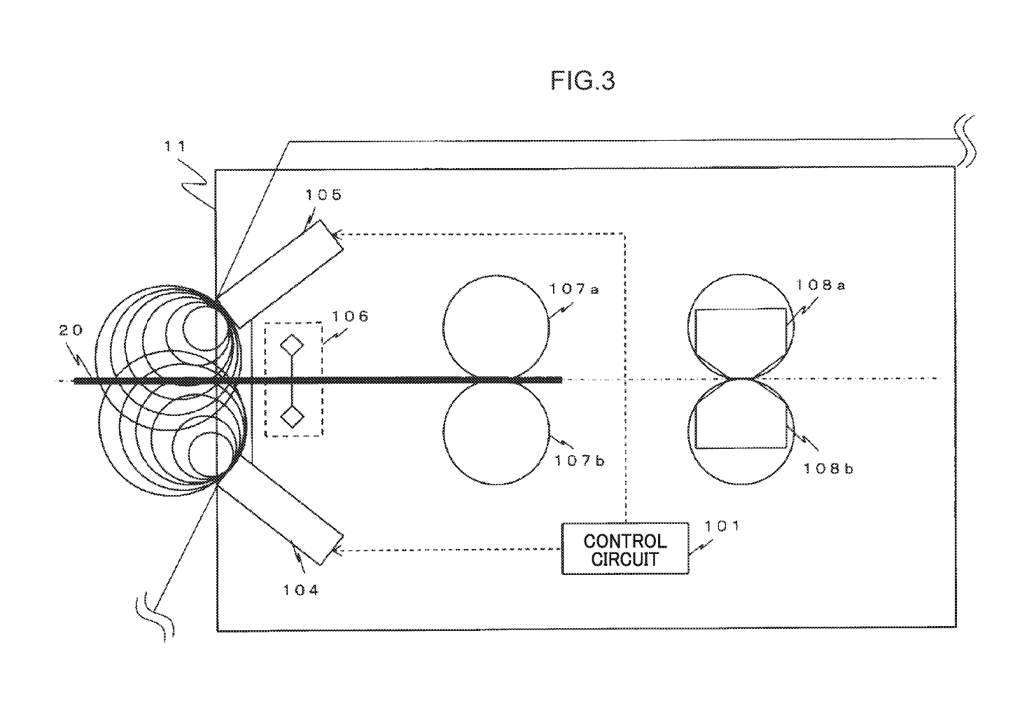

FIG. 3 is an internal configuration diagram illustrating an internal configuration of the medium processing device 11 according to the first exemplary embodiment. Note that in order to facilitate explanation, FIG. 3 explains a state in which a card 20 is being inserted.

In FIG. 3, the medium processing device 11 according to the first exemplary embodiment includes a control circuit 101, a data read obstruction/detection section 104, a data read obstruction/detection section 105, a conveyance detection sensor 106, a pair of conveyor rollers 107a and 107b, and magnetic head sections 108a and 108b.

The control circuit 101 controls operation of the data read obstruction/detection section 104 and the data read obstruction/detection section 105 according to transaction processing by the controller 13. Namely, the control circuit 101 controls switching between a mode that obstructs reading data on the magnetic strip of the card, and a mode that detects magnetic data readers, while switching operation modes of the data read obstruction/detection section 104 and the data read obstruction/detection section 105 according to the operation state of the ATM 1 and the processing state during transactions.

For example, it is expected that the illicitly attached magnetic data reader will read data when the card is being inserted into or being dispensed from the card input/output port 12. Accordingly, the control circuit 101 preferably performs an operation to obstruct reading of data at least when a card is being inserted into the card input/output port 12 and when a card is being dispensed form the card input/output port 12. More specifically, in cases in which, for example, a transfer transaction is performed as a pay-in transaction, when a card is inserted after starting a transfer transaction, or when a card is being dispensed after completing a transfer transaction, the control circuit 101 switches the operation mode to an obstruction mode and the control circuit 101 applies a voltage to the data read obstruction/detection section 104 and the data read obstruction/detection section 105 to generate an obstructing magnetic field.

Moreover, for example, it is preferable to provide a monitoring period that is as long as possible since it is not known at what timing a magnetic data reader will be illicitly attached. The control circuit 101 therefore performs control so as to operate in a detection mode in periods other than when operating in the obstruction mode. More specifically, in periods such as those in which the ATM 1 is not dealing with a customer, or, in cases in which a customer is performing a transaction using the ATM 1, in periods in which the obstruction mode is not operating during the transaction, the control circuit 101 switches the operation mode to the detection mode, and the control circuit 101 applies a specific voltage to the data read obstruction/detection section 104 and the data read obstruction/detection section 105 so as to generate a magnetic field for detecting illicit attachment of a magnetic data reader. The control circuit 101 detects the presence or absence of a secondary magnetic field generated by metal based on the magnetic field received by the data read obstruction/detection section 104 and the data read obstruction/detection section 105. In cases in which a secondary magnetic field is being generated, the control circuit 101 regards this as illicit attachment of a magnetic data reader, and notifies the controller 13 of this.

The data read obstruction/detection section 104 and the data read obstruction/detection section 105 generate magnetic fields for obstructing reading of magnetic data. Moreover, the data read obstruction/detection section 104 and the data read obstruction/detection section 105 detect metal built into magnetic data readers in order to illicitly attached detect magnetic data readers. Namely, the data read obstruction/detection section 104 and the data read obstruction/detection section 105 operate as a data reading obstruction device and a magnetic data reader 30 detecting device.

Explanation follows regarding the data read obstruction/detection section 104 and the data read obstruction/detection section 105.

The data read obstruction/detection section 104 generates a magnetic field in a direction facing upward from below the card 20 being inserted into the card input/output port 12. On the other hand, the data read obstruction/detection section 105 generates a magnetic field facing downward from above the card 20 being inserted into the card input/output port 12. The data read obstruction/detection section 104 and the data read obstruction/detection section 105, serving as two data reading obstruction sections, are provided above and below the card 20 being inserted in order to be appropriate for the position of the magnetic strip affixed to the card 20. For example, a card standardized using reference technology of the Japanese Industrial Standards (JIS) of the Japanese Industrial Standards Committee (JISC) is affixed with a magnetic strip on the upper face of the card, and a card standardized using reference technology of the International Organization for Standardization (ISO) is affixed with a magnetic strip on the lower face of the card. Two sections, namely, the data read obstruction/detection section 104 and the data read obstruction/detection section 105, are therefore provided above and below the card 20 being inserted in order to enable compatibility with standards applied for cards. Note that a single data reading obstruction section may be provided either above or below the card in order to obstruct reading of data from a card 20 based on a particular standard.

Moreover, the data read obstruction/detection section 104 and the data read obstruction/detection section 105 may employ, for example, a coil circuit such as an antenna coil or a solenoid.

For example, the data read obstruction/detection section 104 and the data read obstruction/detection section 105, which function as data reading obstruction devices, are applied with a voltage from the control circuit 101, and generate a magnetic field (obstructing magnetic field) via current flowing in the coil circuit. The obstructing magnetic field is preferably received by the magnetic data reader 30 as noise. Namely, when the magnetic data reader 30 reads the magnetic data and regenerates the waveform of the magnetic data, the original data (namely, the data of the magnetic strip) cannot be reconstructed due to the obstructing magnetic field being received as noise. The strength of the obstructing magnetic field is not limited to a fixed strength, and may be made variable. Moreover, the effective range of the obstructing magnetic field may be, for example, a specific range (for example, a range of approximately 30 mm) around the position of the data read obstruction/detection section 104 and the data read obstruction/detection section 105, which function as data reading obstruction devices.

Moreover, for example, in cases in which the data read obstruction/detection device 104 and the data read obstruction/detection section 105 function as a magnetic data reader 30 detecting device, the data read obstruction/detection device 104 and the data read obstruction/detection section 105 generate a magnetic field via current flowing in the coil circuit, based on the voltage applied from the control circuit 101. When the data read obstruction/detection device 104 and the data read obstruction/detection section 105 generate a magnetic field, an overcurrent is generated by metal installed in the magnetic data reader 30, and a secondary magnetic field is generated. The data read obstruction/detection device 104 and the data read obstruction/detection section 105 receive the secondary magnetic field generated by the overcurrent of the metal. The control circuit 101 detects the magnetic data reader 30 by detecting the secondary magnetic field originating from the overcurrent of the metal based on the signal received by the data read obstruction/detection device 104 and the data read obstruction/detection section 105. Namely, the data read obstruction/detection device 104 and the data read obstruction/detection section 105 find metal included in the magnetic data reader 30 using metal finding functionality.

The effective range of the magnetic field generated by the data read obstruction/detection device 104 and the data read obstruction/detection section 105, which provide metal finding functionality, is set to, for example, a specific range (for example, a range of approximately 10 mm) around the position of the data read obstruction/detection section 104 and the data read obstruction/detection section 105. The effective range of the magnetic field may be a narrow range when generated as an obstructing magnetic field. This is because, although the range is dependent on the position where the data read obstruction/detection device 104 and the data read obstruction/detection section 105 are installed, it is sufficient to detect a fixed magnetic data reader 30 since the magnetic data reader 30 will be illicitly attached in a fixed position. However, in the case of the obstructing magnetic field, it is preferable to generate a comparatively strong magnetic field over a comparatively wide range so as to also reliably prevent reading of magnetic data.

Although the first exemplary embodiment gives an example of a case in which the data read obstruction/detection device 104 and the data read obstruction/detection section 105 both function as the obstructing device and the magnetic data reader detecting device, one out of the data read obstruction/detection device 104 or the data read obstruction/detection section 105 alone may function as the magnetic data reader 30 detecting device.

Moreover, the data read obstruction/detection device 104 and the data read obstruction/detection section 105 operating in the detecting mode have been explained as devices that generate a magnetic field and receive a secondary magnetic field. However, the data read obstruction/detection device 104 may function as a magnetic field generator, and the data read obstruction/detection section 105 may function as a magnetic field receiver. Namely, the magnetic field generator and the secondary magnetic field receiver may be physically distinct sections.

The conveyance detection sensor 106 is a device that detects insertion of a card into the card input/output port 12, and dispensing of a card from the card input/output port 12. As illustrated in FIG. 3, the conveyance detection sensor 106 is, for example, a set of sensors provided vertically across a conveyance path, but is not limited to such an example. The conveyance detection sensor 106 provides detection information related to insertion and dispensing of the card to the control circuit 101 for the purpose of switching the operation mode. Moreover, the conveyance detection sensor 106 provides detection information related to insertion and dispensing of the card to the controller 13 for the purpose of executing transaction processing.

The conveyor rollers 107a, 107b convey the card in order to insert or dispense the card. The conveyor rollers 107a and the 107b can be rotated in both directions by a driving force from a drive section such as a motor, not illustrated in the drawings, and perform card insertion and card dispensing.

The magnetic head sections 108a, 108b read magnetic data from the magnetic strip of the card conveyed by the conveyor rollers 107a, 107b, or write magnetic data to the magnetic strip.

(A-2) Operation of First Exemplary Embodiment

(A-2-1) Operation Mode Switching Processing

Next, detailed explanation follows regarding processing for switching the operation mode between data read obstruction processing and detection processing in the medium processing device 11 according to the first exemplary embodiment, with reference to the drawings.

Although the medium processing device 11 according to the first exemplary embodiment is compatible with cases in which various transactions are performed in the ATM 1, an example is given of operation when pay-in processing is performed as an example of the various transactions of the ATM 1.

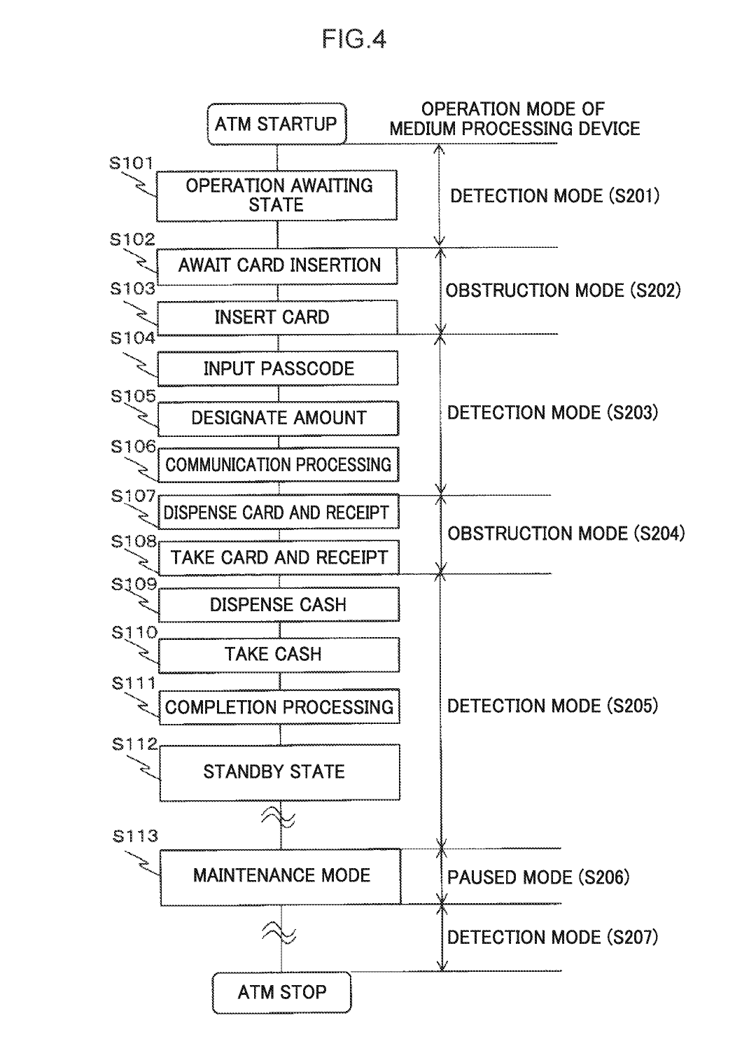

FIG. 4 is an explanatory diagram for explaining processing operations by the medium processing device 11 in cases in which pay-in processing is performed in the ATM 1 according to the first exemplary embodiment.

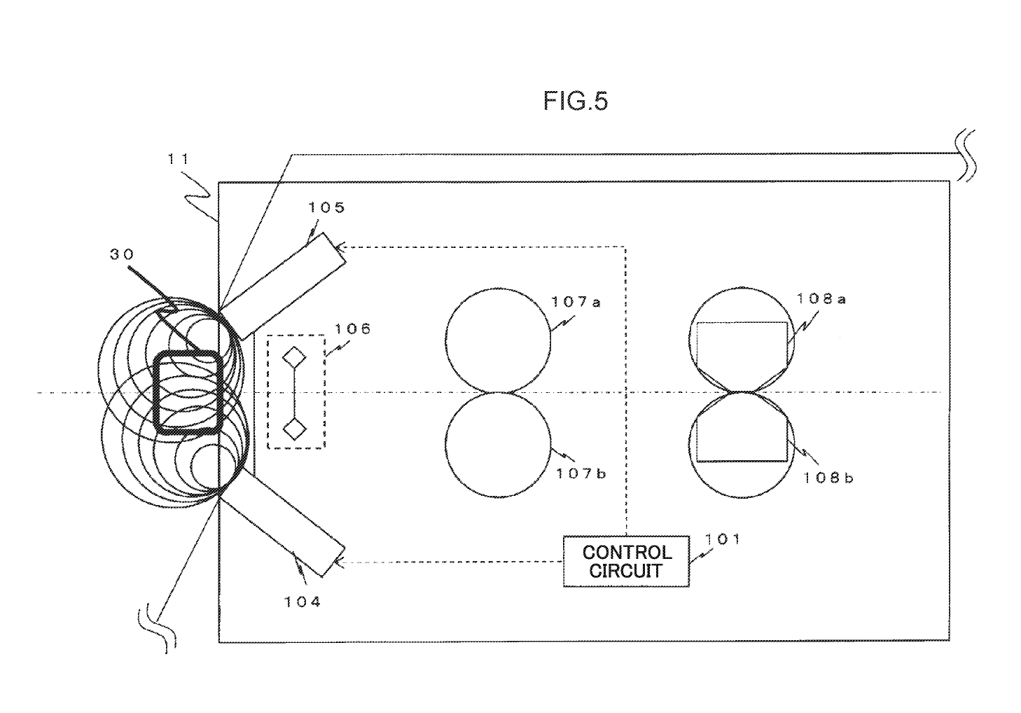

In FIG. 4, when a power source of the ATM 1 is set to ON and the ATM 1 starts up, an operation standby state is adopted by the ATM 1 (S101). In this event, the medium processing device 11 operates in the detection mode that detects illicit attachment of the magnetic data reader 30 (S201) (see FIG. 5). In the medium processing device 11, the control circuit 101 switches the operation mode to the detection mode, the control circuit 101 applies a voltage to the data read obstruction/detection device 104 and the data read obstruction/detection section 105, and the data read obstruction/detection device 104 and the data read obstruction/detection section 105 generate a magnetic field toward the vicinity of the card input/output port 12 in order to find metals.

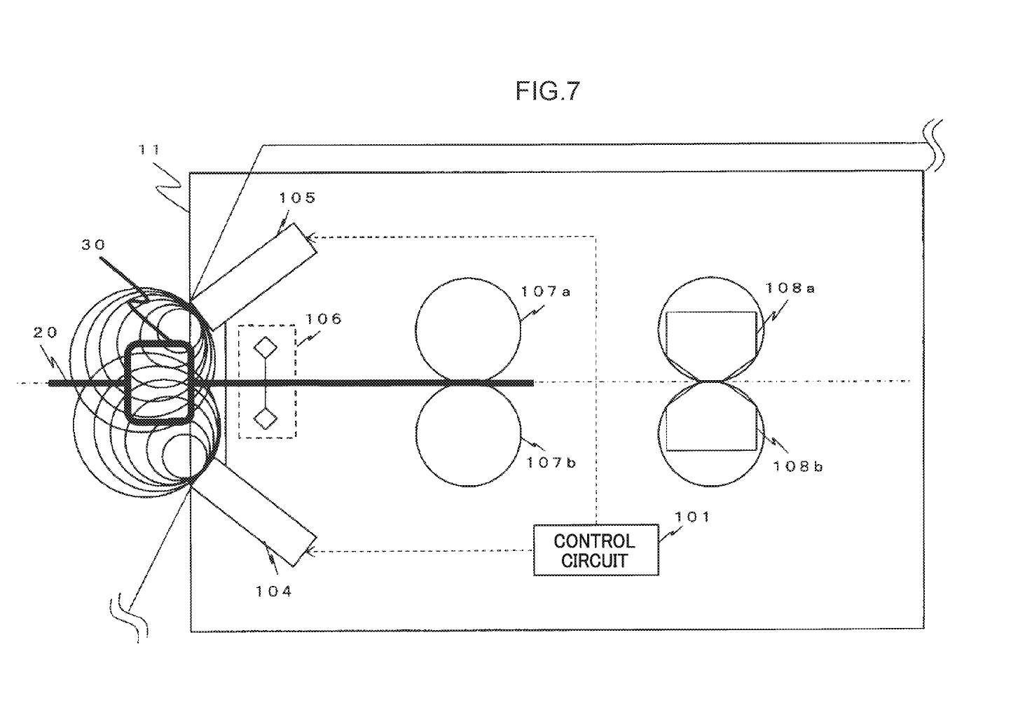

In the ATM 1, when a pay-in transaction has been started by customer operation and card insertion is being awaited (S102), as illustrated in FIG. 7, the medium processing device 11 operates in the obstruction mode that obstructs reading of magnetic data (S202) until a card has been inserted into the card input/output port 12 (S103). In this event, in the medium processing device 11, the control circuit 101 switches the operation mode to the obstruction mode, the control circuit 101 applies a voltage to the data read obstruction/detection device 104 and the data read obstruction/detection section 105, and the data read obstruction/detection device 104 and the data read obstruction/detection section 105 generate a magnetic field for obstructing magnetic data reading toward the vicinity of the card input/output port 12.

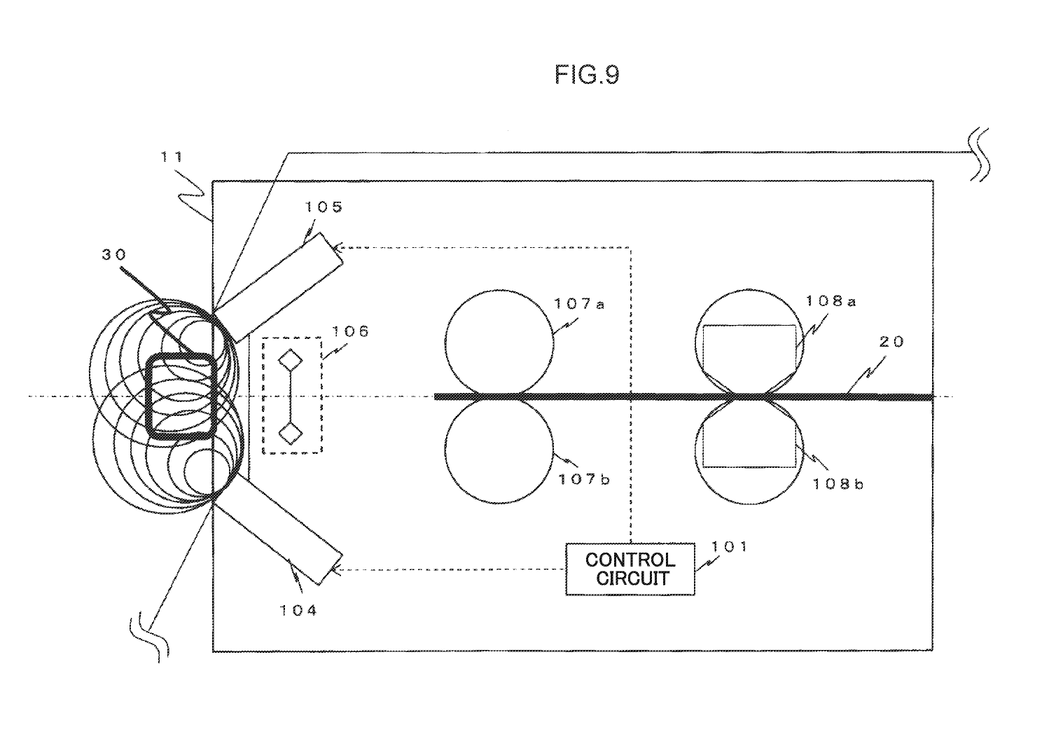

Moreover, after the card has been inserted as illustrated in FIG. 9, when a passcode has been input by the customer (S 104) and a designation of an amount for paying in has been input (S105), the ATM 1 performs transaction information communication processing with the financial institution host server (S106). In this event, the control circuit 101 switches the operation mode in the medium processing device 11 to the detection mode (S203).

Namely, when a card has been inserted and processing is performed while illicit magnetic data reading processing is not believed to be being performed by an illicitly attached magnetic data reader 30, the control circuit 101 switches the operation mode from the obstruction mode to the detection mode. Thus, even when a perpetrator of illicit activity has attached a magnetic data reader 30 after the card was inserted, the magnetic data reader 30 illicitly attached at that time can be detected.

Moreover, when the pay-in transaction has completed in the ATM 1, the card that was inserted, and a receipt detailing the transaction information, are dispensed (S107) and the card and receipt are taken by the customer (S108). In this event, the control circuit 101 switches the operation mode in the medium processing device 11 to the obstruction mode (S204).

Namely, illicit reading of magnetic data from the magnetic strip of the card is not only a risk during insertion of the card, but also during dispensing of the card. The control circuit 101 is therefore able to switch the operation mode to the obstruction mode so that the obstructing magnetic field is generated from the data read obstruction/detection device 104 and the data read obstruction/detection section 105 in order to obstruct illicit reading of magnetic data from the card being dispensed.

Subsequently, cash for the pay-in transaction is dispensed (S109), and the cash is taken by the customer (S110), and the pay-in transaction completes in the ATM 1 (S111). The ATM 1 adopts a standby state after completing the transaction (S112). After the card has been dispensed, when processing for cash is dispensed or the like, the control circuit 101 thus switches the operation mode in the medium processing device 11 to the detection mode (S205).

Namely, since a case is conceivable in which a magnetic data reader 30 is illicitly attached when the transaction completes and the customer leaves the ATM 1, detection of a magnetic data reader 30 illicitly attached at that time is enabled.

As described above, when a transaction is being performed by the ATM 1, when processing for card insertion or for card dispensing is being performed, the control circuit 101 of the medium processing device 11 switches the operation mode to the obstruction mode to obstruct illicit reading of the magnetic data.

However, during processing other than that for card insertion or card dispensing, the control circuit 101 of the medium processing device 11 switches the operation mode to the detection mode so that illicit attachment of the magnetic data reader 30 can be detected.

In cases in which, for example, the ATM 1 is undergoing maintenance by maintenance staff, the control circuit 101 of the medium processing device 11 may switch the operation mode in the ATM 1 to a paused mode. Namely, in cases in which the ATM 1 is operated in maintenance mode by a maintenance staff, the control circuit 101 prepares a paused mode in which neither the detection mode nor the obstruction mode operate, and switches to the paused mode, in order to prevent erroneous detection or erroneous operation during servicing. While, for example, pulling out a cash storage box from inside the ATM 1, when a sensor has detected that a front panel is OPEN, the control circuit 101 may switch the operation mode to the paused mode such that functionality for obstructing reading of the magnetic data of the medium processing device 11, and functionality for detecting the illicitly attached magnetic data readers 30, are paused.

(A-2-2) Magnetic Data Reader 30 Detection Processing

FIG. 5 is an explanatory diagram for explaining the detection mode of the medium processing device 11 according to the first exemplary embodiment. FIG. 5 illustrates a state in which a magnetic data reader has been illicitly attached to the card input/output port 12.

The data read obstruction/detection device 104 and the data read obstruction/detection section 105 are provided in advance so as to generate a magnetic field toward the vicinity of the card input/output port 12. As illustrated in FIG. 5, when the magnetic data reader 30 is illicitly attached to the card input/output port 12, metal generally installed in the magnetic data reader 30 generates a secondary magnetic field via the magnetic field. The data read obstruction/detection device 104 and the data read obstruction/detection section 105 then receive the secondary magnetic field generated by the metal, and when the control circuit 101 has detected the secondary magnetic field caused by the metal (namely, a change in the magnetic field), a magnetic field data reader 30 is thought to have been illicitly attached. More specifically, when the control circuit 101 continuously detects a secondary magnetic field for a specific amount of time or longer (for example, for one second or for several seconds), the control circuit 101 determines that metal has been detected.

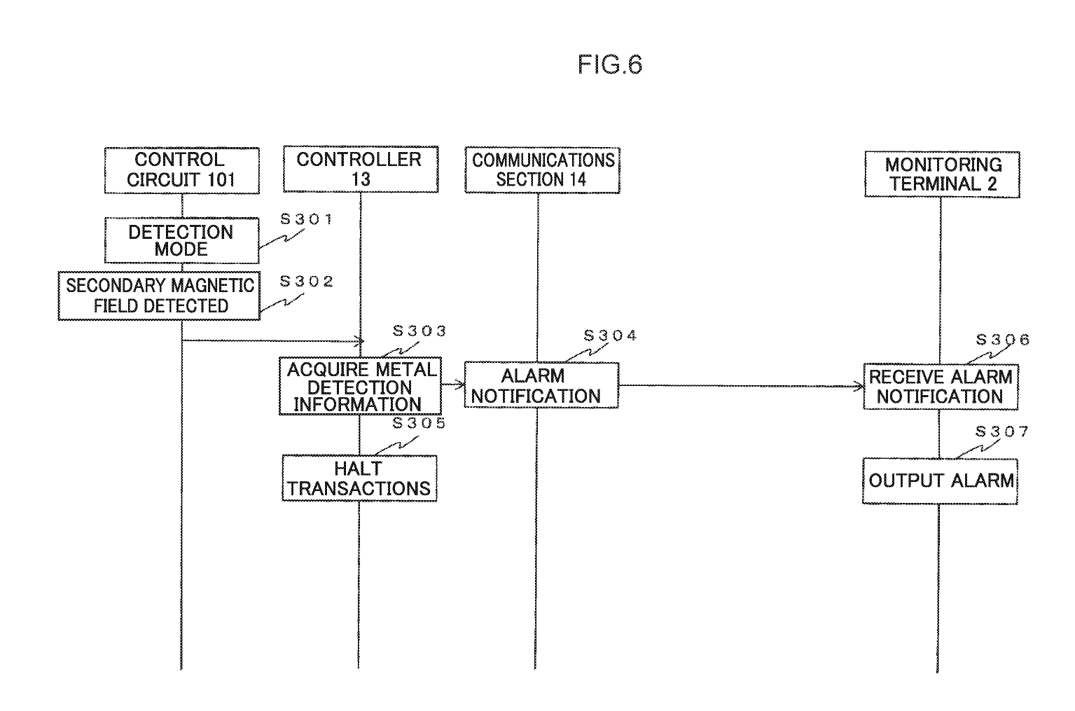

FIG. 6 is an explanatory diagram for explaining a processing operation when the magnetic data reader 30 has been detected according to the first exemplary embodiment.

First, when the control circuit 101 is operating in detection mode (S301), when the control circuit 101 has detected that a secondary magnetic field is being generated (a change in the received magnetic field) (S302) based on the magnetic field received by the data read obstruction/detection devices 104, 105, the control circuit 101 notifies the controller 13 of this.

When the controller 13 has acquired metal detection information from the control circuit 101 (S303), the controller 13 issues an alarm notification to the monitoring terminal 2 via the communications section 14 (S304). In this event, the controller 13 may incorporate, for example, information identifying the ATM 1, and detection time information that includes the date and time, time of day, or the like of detection, into an alarm notification indicating the illicit attachment of the magnetic data reader 30.

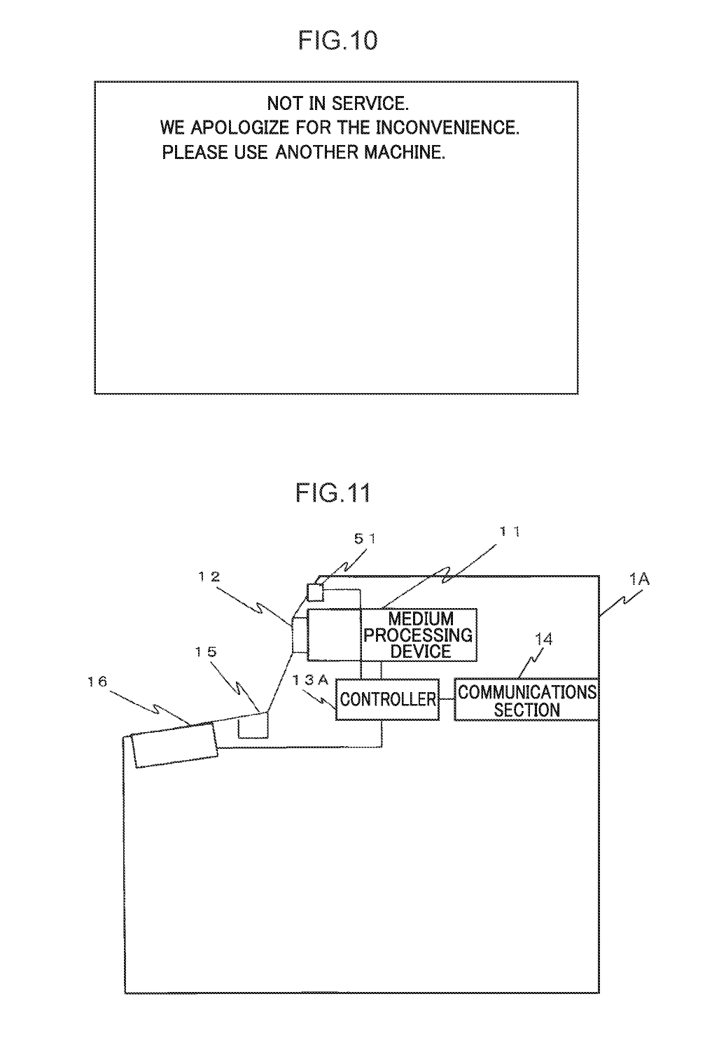

In this event, when the controller 13 has acquired the metal detection information from the control circuit 101, it is thought that the magnetic data reader 30 has been illicitly attached, and transactions are halted so as to halt dealings with the ATM 1 (S305). When, for example, the magnetic data reader 30 has been detected prior to card insertion, processing to halt dealing with the ATM 1 may, for example, display a guidance display such as “Not in service. We apologize for the inconvenience. Please use another machine.” on the operation panel section 16 as illustrated in FIG. 10, and may halt input operations. Moreover, for example, insertion of cards may be halted when the magnetic data reader 30 has been detected after insertion of a card. More specifically, the card may be dispensed, and the shutter of the card input/output port 12 may be closed such that cards cannot be inserted.

When the alarm notification has been received by the monitoring terminal 2 (S306), an alarm may be output (S307), and monitoring personnel may be notified of the alarm. This enables monitoring personnel to be made aware that the magnetic data reader 30 has been illicitly attached on the ATM 1 that issued the alarm notification, and, for example, enables confirmation to be made by, for example, immediately dispatching of security. The monitoring terminal 2 may store information included in the alarm notification (such as information identifying the ATM 1, or detection time information) as history information.

(A-2-3) Magnetic Data Reader Obstruction Processing

FIG. 7 is an explanatory diagram for explaining the obstruction mode of the medium processing device 11 according to the first exemplary embodiment. FIG. 7 illustrates a state in which the magnetic data reader 30 is illicitly attached to the card input/output port 12, and a card is being inserted or being dispensed.

The data read obstruction/detection device 104 and the data read obstruction/detection section 105 are provided so as to generate an obstructing magnetic field for preventing illicit reading of magnetic data, facing the vicinity of the card input/output port 12.

The obstructing magnetic field generated by the data read obstruction/detection device 104 and the data read obstruction/detection section 105 are received as noise by the magnetic data reader 30 when the magnetic data reader 30 illicitly reads magnetic data during card insertion or during card dispensing, such that the magnetic data cannot be reconstructed.

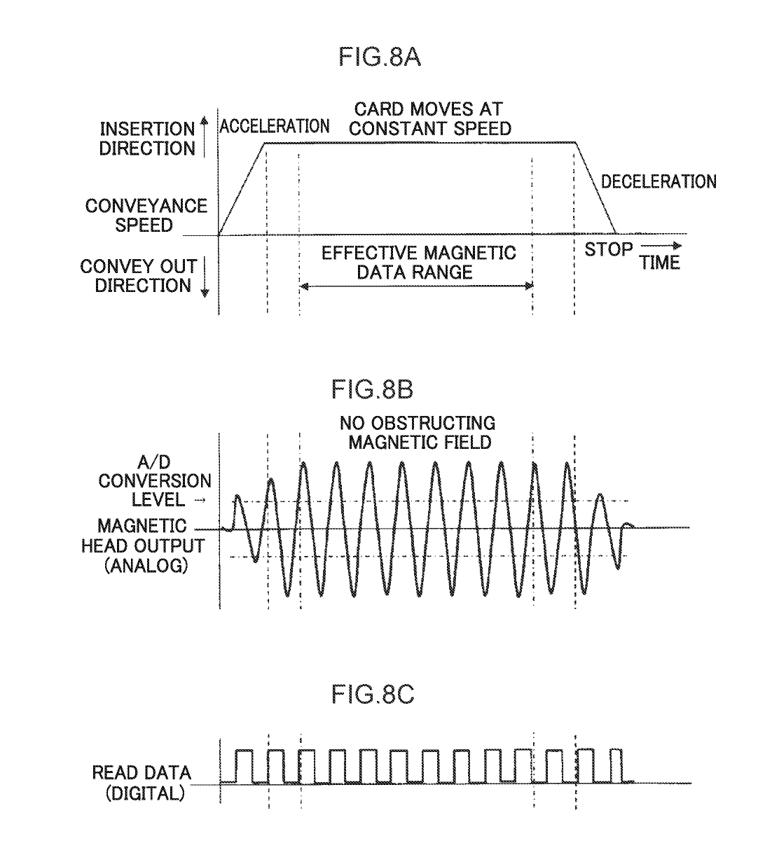

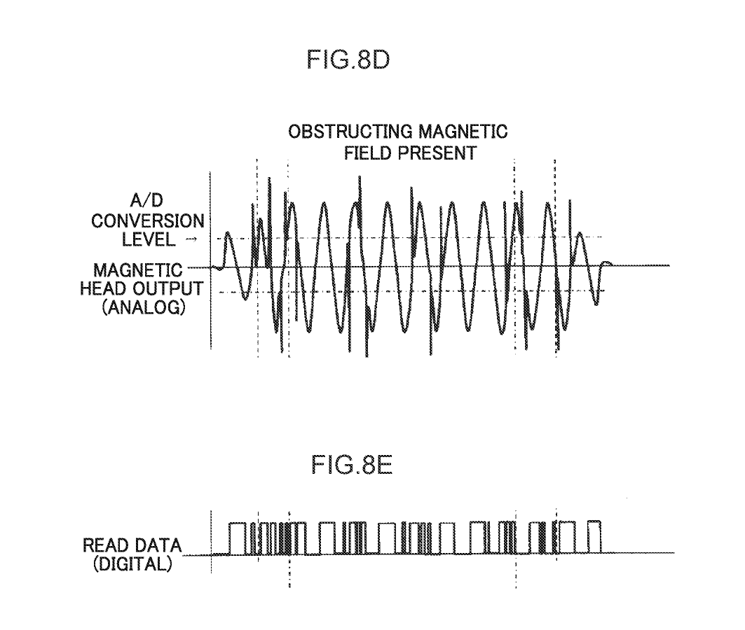

FIG. 8A to FIG. 8E are explanatory diagrams for explaining regeneration of magnetic data by the magnetic data reader 30 under the obstruction mode of the medium processing device 11 according to the first exemplary embodiment.

FIG. 8A is an explanatory diagram for explaining a conveyance speed of a card inserted into the card input/output port 12. FIG. 8A displays time on the horizontal axis and conveyance speed on the vertical axis. As illustrated in FIG. 8A, the conveyor rollers 107a, 107b accelerate the conveyance speed of the inserted card so as to convey the card toward the back of a conveyance path, and after a specific amount of time, convey the card further toward the back at a specific speed. In this event, the magnetic head sections 108a, 108b installed in the medium processing device 11 read the magnetic data from the magnetic strip of the card. Subsequently, the conveyor rollers 107a, 107b reduce the conveyance speed of the card, and then stop the conveyance speed to house the card inside the medium processing device 11.

FIG. 8B and FIG. 8C are depictions illustrating an analog regenerated waveform and a decoded waveform of the magnetic data made by the magnetic data reader 30 in a case in which there is no obstructing magnetic field from the medium processing device 11. FIG. 8D and FIG. 8E are depictions illustrating an analog regenerated waveform and a decoded waveform of the magnetic data made by the magnetic data reader 30 in a case in which there is an obstructing magnetic field from the medium processing device 11.

As illustrated in FIG. 8B, in cases in which there is no obstructing magnetic field, a magnetic head of the magnetic data reader 30 regenerates the analog waveform of the magnetic data from the inserted card, and in particular, the magnetic head regenerates the received waveform when the card is moving at a constant speed. Thus, it is apparent that the magnetic data of the card is reconstructed as illustrated in FIG. 8C when analog/digital conversion is performed by the magnetic data reader 30.

However, as illustrated in FIG. 8D, in cases in which there is an obstructing magnetic field, the magnetic head of the magnetic data reader 30 receives the obstructing magnetic field as noise, and regenerates a distorted analog waveform. Thus, as illustrated in FIG. 8E, reconstruction of the magnetic data of the card by analog/digital conversion can be obstructed. This enables normal reading of the magnetic field data to be obstructed.

Note that, as long as a magnetic field is generated that can be received as noise by the magnetic data reader 30, the data read obstruction/detection device 104 and the data read obstruction/detection section 105 may, for example, change the strength of the magnetic field so as to obstruct reconstruction of the magnetic data.

(A-3) Advantageous Effects of First Exemplary Embodiment

As described above, according to the first exemplary embodiment, a medium processing device is provided that has both functionality for obstructing reading of magnetic data and detection functionality for detecting illicit attachment of a magnetic data reader, thereby enabling occupied space to be minimized further than when separate devices are individually fitted.

According to the first exemplary embodiment, operation is performed in the obstruction mode during card insertion/dispensing operations, and operation is performed in the detection mode at times other than during card insertion/dispensing operations. Thus, in cases in which a magnetic data reader (skimming device) has been attached, dealings with the ATM can be halted and a notification issued to monitoring so that measures to confirm the situation, remove skimming devices, or the like can be immediately taken.

(B) Second Exemplary Embodiment

Next, detailed explanation follows regarding an automatic teller machine and a medium processing device according to a second exemplary embodiment of the present invention, with reference to the drawings.

Similarly to the first exemplary embodiment, the second exemplary embodiment also gives an example of a case in which the present invention is applied to an ATM or monitoring system installed in a financial institution, a convenience store, a train station, an airport, or the like.

(B-1) Configuration of Second Exemplary Embodiment

FIG. 11 is a block diagram illustrating primary configuration of an ATM 1A according to the second exemplary embodiment. In FIG. 11, the ATM 1A according to the second exemplary embodiment includes a monitoring camera 51 in addition to the medium processing device 11, the card input/output port 12, the controller 13A, the communications section 14, the pay-in/pay-out section 15, the operation panel section 16, etc. explained in the first exemplary embodiment.

The monitoring camera 51 images customers who use the ATM 1, and provides imaging data to the controller 13A. As illustrated in FIG. 11, the monitoring camera 51 is, for example, provided above the card input/output port 12, and images operations and the like performed by the user. Although an example is given of a case in which the monitoring camera 51 is installed in the ATM 1 in the present exemplary embodiment, the monitoring camera 51 may be provided in the vicinity of the ATM 1. Moreover, the monitoring camera 51 is not limited to being a single unit, and there may be plural units thereof.

The controller 13A manages functionality of the ATM 1, similarly to in the first exemplary embodiment. The controller 13A stores imaging data imaged by the monitoring camera 51 when an illicitly attached magnetic data reader 30 was detected by the medium processing device 11. The controller 13A also transmits imaging data of the monitoring camera 51 to the monitoring terminal 2 via the communications section 14 when the magnetic data reader 30 is detected. This enables perpetrators of illicit activity who have performed illicit operations in, for example, the vicinity of the card input/output port 12 to be identified since the images captured by the monitoring camera 51 when the magnetic data reader 30 is detected can also be provided to the monitoring terminal 2.

(B-2) Operation of the Second Exemplary Embodiment

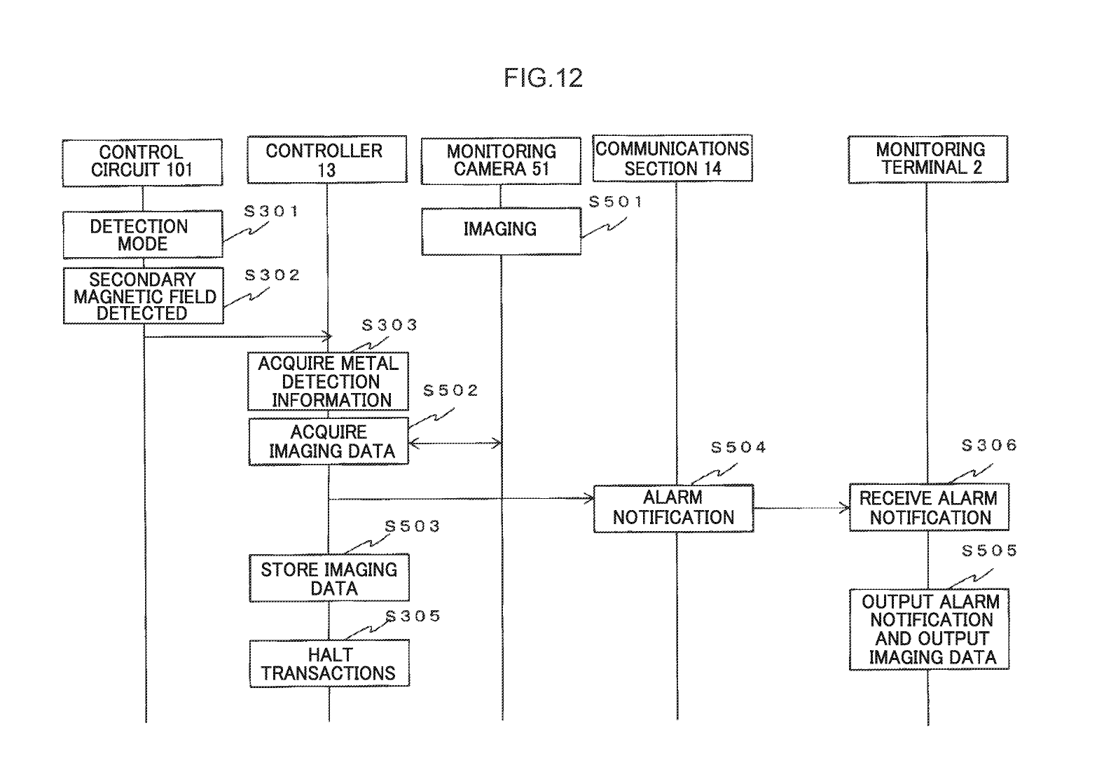

FIG. 12 is an explanatory diagram for explaining processing operations when the magnetic data reader 30 has been detected according to the second exemplary embodiment. In FIG. 12, processing identical or corresponding to that of FIG. 6 according to the first exemplary embodiment is allocated the same reference numerals.

The monitoring camera 51 images customers standing in front of the ATM 1 (S501). Here, the monitoring camera 51 may, for example, constantly capture images, or may start capturing images due to detection by a sensor (for example, a human presence sensor or a touch sensor of the operation panel section 16) included in the ATM 1.

Similarly to in the first exemplary embodiment, the medium processing device 11 operates in the obstruction mode during card insertion and during card dispensing, and operates in the detection mode at times other than during card insertion and during card dispensing. When the control circuit 101 has detected a secondary magnetic field (S302) while the medium processing device 11 is operating in detection mode, the control circuit 101 notifies the controller 13A of this.

When the controller 13A has acquired metal detection information from the control circuit 101 (S303), the controller 13A considers this as detection of a magnetic data reader 30, and the controller 13A acquires imaging data of the monitoring camera 51 (S502) and stores the imaging data (S503). In this event, the imaging data may, for example, be stored in a file format, and date and time information (for example, date or time information) or information identifying the ATM 1A (for example, a store name, a branch name, or an identifier number of the ATM 1A) from when the magnetic data reader 30 was detected by the control circuit 101 is stored associated with the imaging data. For example, date and time information may also be incorporated into a file as data, or the date and time information may be appended to the filename.

The controller 13A issues an alarm notification including the imaging data from when the magnetic data reader 30 was detected to the monitoring terminal 2 via the communications section 14 (S504). In this event, the controller 13A incorporates, for example, imaging data from when the magnetic data reader 30 was detected, information identifying the ATM 1, and detection time information including the date and time, time of day, or the like at which detection was made.

Moreover, when the controller 13A has acquired metal detection information from the control circuit 101, the controller 13A considers a magnetic data reader 30 to have been illicitly attached, and halts transactions in order to halt dealings with the ATM 1A (S305). Processing to halt dealings with the ATM 1 may apply processing similar to that of the first exemplary embodiment, and detailed explanation thereof is therefore omitted here.

In the monitoring terminal 2, when an alarm notification has been received (S306), an alarm is output and the received imaging data is displayed on a display of the monitoring terminal 2 (S505). This enables monitoring personnel to confirm the alarm notification and the imaging data form when the magnetic data reader 30 was detected, thereby enabling a suspected perpetrator of illicit activity to be identified. Moreover, the monitoring terminal 2 may store, as history information, information included in the alarm notification (for example, the information identifying the ATM 1, and detection time information) together with the imaging data.

(B-3) Advantageous Effects of Second Exemplary Embodiment

As described above, according to the second exemplary embodiment, in addition to the advantageous effects of the first exemplary embodiment, photographic evidence identifying a suspected perpetrator of illicit activity can be acquired from imaging data of a person thought to have attached the magnetic data reader.

(C) Other Exemplary Embodiments

Although various modified exemplary embodiments of each of the exemplary embodiments described above have been mentioned, the present invention can also be applied in the following exemplary embodiments.

(C-1) In each of the exemplary embodiments described above, examples have been given of cases in which the medium processing device reads magnetic data from the magnetic strip of the inserted card. However, the medium processing device may read magnetic data from a magnetic strip affixed to an inserted passbook. Namely, magnetic data readers can also be attached on passbook input/output ports, and the medium processing device according to the present invention may detect magnetic data readers illicitly attached to the passbook input/output port and may obstruct magnetic data readers from reading magnetic data.

(C-2) In each of the exemplary embodiments described above, examples have been given of cases in which the control circuit of the medium processing device operates in the paused mode when the ATM is in maintenance mode. However, the paused mode is not limited to use when the ATM is in maintenance mode, and the control circuit may switch to paused mode as appropriate depending on the situation in which the ATM is provided. For example, when the ATM is installed in a hospital or the like, the control circuit may be capable of switching to paused mode depending on the specific time period, such as at night (for example, from 8pm to 7am).

Moreover, the paused mode is configured as an operation mode in which neither the obstruction mode nor the detection mode operate. However, the paused mode may be an operation mode in which operation of one alone out of the obstruction mode or the detection mode is paused. For example, since there is a risk of an illicit attachment of a magnetic data reader causing further harm, configuration may be made such that only the detection mode operates, and only the obstruction mode is paused. Conversely, when the ATM is installed in a hospital or the like, configuration may be made such that only the obstruction mode operates, and the detection mode is paused, in order to reduce the influence of the magnetic field.

(C-3) In each of the exemplary embodiments described above, examples have been given of cases in which the controller 13 that controls functionality of the ATM 1 controls halting of dealings with the ATM and controls issuing of alarm notifications and the like to the monitoring terminal. However, configuration may be made such that, for example, the control circuit of the medium processing device, a controller provided separately from the ATM, or the like performs processing of the controller 13 explained in each of the exemplary embodiments described above.

The entire content of the disclosure of Japanese Patent Application No. 2014-097379 filed May 9, 2014 is incorporated by reference in the present specification.

1. An automatic teller machine that performs specific transaction processing using a medium to which a magnetic data storage section is affixed, the automatic teller machine comprising:
a plurality of illicit device detectors that generate a magnetic field toward a vicinity of an input/output port for a medium and capture changes in a magnetic field caused by metal;
a plurality of magnetic data obstruction sections that generate a magnetic field and obstruct reading of magnetic data stored on a magnetic data storage section affixed to an inserted medium or a medium being dispensed; and
a controller that controls operation of the magnetic data obstruction section and the illicit device detector operation,
one of the illicit device detectors and another of the illicit device detectors being provided at an angle, and
one of the magnetic data obstruction sections and another of the magnetic data obstruction sections being provided at an angle.

2. The automatic teller machine of claim 1, wherein the controller causes each of the magnetic data obstruction sections to operate when the medium is being inserted or dispensed, and causes each of the illicit device detectors to operate at times other than when the medium is being inserted or dispensed.

3. The automatic teller machine of claim 1, wherein the controller detects attachment of an illicit device when a change in a magnetic field has been detected by each of the illicit device detectors.

4. The automatic teller machine of claim 3, wherein the controller halts transaction processing in the automatic teller machine when a change in a magnetic field has been detected by each of the illicit device detectors.

5. The automatic teller machine of claim 3, wherein the controller issues an alarm notification to an externally connected monitoring terminal when a change in a magnetic field has been detected by each of the illicit device detectors.

6. The automatic teller machine of claim 3, further comprising an imaging section that images a user of the automatic teller machine, wherein
the controller saves imaging data from the imaging section during detection when a change in a magnetic field has been detected by each of the illicit device detectors.

7. The automatic teller machine of claim 3, further comprising an imaging section that images a user of the automatic teller machine, wherein
the controller issues an alarm notification including imaging data from the imaging section during detection to an externally connected monitoring terminal when a change in a magnetic field has been detected by each of the illicit device detectors.

8. The automatic teller machine of claim 1, wherein the controller pauses the operation of the magnetic data obstruction section and the illicit device detector during maintenance of the automatic teller machine.

9. The automatic teller machine of claim 1, wherein each of the respective illicit device detectors and each of the respective magnetic data obstruction sections are each in a same respective magnetism generator, and switch operation modes based on a switching operation by the controller.

10. A medium processing device comprising:
one or a plurality of illicit device detectors that generate a magnetic field toward a vicinity of an input/output port for a medium and capture changes in a magnetic field caused by metal;
one or a plurality of magnetic data obstruction sections that generate a magnetic field and obstruct reading of magnetic data stored on a magnetic data storage section affixed to an inserted medium or a medium being dispensed; and
a controller that controls the magnetic data obstruction section and the illicit device detector operation,
the illicit device detectors and the data reading obstruction sections being provided at an angle.

11. The medium processing device of claim 10, wherein:
extension axes of one central axis and another central axis of the illicit device detectors intersect with each other; and
extension axes of one central axis and another central axis of the magnetic data obstruction sections intersect with each other.

12. The medium processing device of claim 11, wherein the intersection on the extension axes is present in the vicinity of a card input/output port provided on the automatic teller machine.

13. The medium processing device of claim 10, wherein each of the respective illicit device detectors and each of the respective magnetic data readers are each in a same respective magnetism generator.

14. An automatic teller machine that performs specific transaction processing using a medium to which a magnetic data storage section is affixed, the automatic teller machine comprising:
a plurality of illicit device detectors that generate a magnetic field toward a vicinity of an input/output port for a medium and capture changes in a magnetic field caused by metal;
a plurality of magnetic data obstruction sections that generate a magnetic field and obstruct reading of magnetic data stored on a magnetic data storage section affixed to a inserted medium or a medium being dispensed; and
a controller that controls the magnetic data obstruction section and the illicit device detector operation,
one of the illicit device detectors and another of the illicit device detectors being provided at an angle, and extension axes of one central axis and another central axis of the illicit device detectors intersecting with each other.

15. The automatic teller machine of claim 14, wherein:
one of the magnetic data obstruction sections and another of the magnetic data obstruction sections are provided at an angle; and
extension axes of one central axis and another central axis of the magnetic data obstruction sections intersect with each other.

16. The automatic teller machine of claim 14, wherein the intersection on the extension axes is present in the vicinity of a card input/output port provided in the medium processing device.

17. An automatic teller machine that performs specific transaction processing using a medium affixed with a magnetic data storage section, the automatic teller machine comprising:
one or a plurality of illicit device detectors that generate a magnetic field toward a vicinity of an input/output port for a medium and capture changes in magnetic field caused by metal;
one or a plurality of magnetic data obstruction sections that generate a magnetic field, and obstruct reading of magnetic data stored on a magnetic data storage section affixed to an inserted medium or a medium being dispensed; and
a controller that controls the magnetic data obstruction section and the illicit device detector operation,
each of the respective illicit device detectors and each of the respective magnetic data obstruction sections each being in a same respective magnetism generator, and switching operation modes based on a switching operation by the controller, and
a plurality of modes being present amongst the operation modes in addition to a paused mode.

18. The automatic teller machine of claim 17, wherein the controller halts transaction processing in the automatic teller machine when a change in a magnetic field has been detected by each of the illicit device detectors.
